(19) United States
(12) Patent Application Publication
(10) Pub. No.: US 2025/0270623 A1
(43) Pub. Date: Aug. 28, 2025

(54) CARRIER APPARATUS AND SEQUENCING SYSTEM

(71) Applicant: GeneMind Biosciences Co., Ltd., Shenzhen (CN)

(72) Inventors: Wusheng Li, Shenzhen (CN); Guangming Wang, Shenzhen (CN)

(21) Appl. No.: 19/052,731

(22) Filed: Feb. 13, 2025

(30) Foreign Application Priority Data
Feb. 26, 2024 (CN) 202420357089.6

(51) Int. Cl. C12Q 1/6816; B01L 3/00

(52) U.S. Cl. CPC C12Q 1/6816; B01L 3/502; B01L 2200/026; B01L 2200/0647; B01L 2300/1883; B01L 2300/1894; B01L 2400/0487

(57) ABSTRACT

The present application discloses a carrier apparatus and a sequencing system. The carrier apparatus according to the embodiments of the present disclosure includes a carrier platform, a fluid connecting assembly, and a movement mechanism. The carrier platform includes a table surface, the table surface being detachably connected to a flow cell assembly; the flow cell assembly includes a flow cell, with a fluid inlet and a fluid outlet being respectively formed at both ends of the flow cell. The fluid connecting assembly includes a manifold arranged in correspondence with the fluid inlet and the fluid outlet. The movement mechanism drives the fluid connecting assembly to move, including: when the fluid connecting assembly is located at a first position, the fluid connecting assembly and the flow cell assembly form a fluid communication through the manifold with the fluid inlet and the fluid outlet; and when the fluid connecting assembly is located at a second position, communication between the fluid connecting assembly and the flow cell assembly is cut off. In the carrier apparatus according to the embodiments of the present disclosure, the fluid connecting assembly is driven by the movement mechanism to move relative to the flow cell assembly, such that the communication between the fluid connecting assembly and the flow cell assembly can be achieved or cut off. The carrier apparatus is simple in structure and convenient to operate.

### TECHNICAL FIELD

The present disclosure relates to the field of gene sequencing, and in particular, to a carrier apparatus and a sequencing system.

### BACKGROUND

Gene sequencing technology refers to techniques for acquiring the base sequence of DNA or RNA by assays. The currently dominant sequencing technology is a high-throughput sequencing technology, and in sequencing platforms for achieving high-throughput sequencing based on sequencing by synthesis, such as Miseq, Nextseq, and Novaseq sequencing platforms of ILLUMINA, a general process of gene sequencing includes fixing a nucleic acid sample to be tested on a flow cell in a hybridization manner. Then, PCR amplification is used to form nucleic acid molecule clusters from the nucleic acid sample to be tested. Next, a sequencing reagent, such as a base with a fluorophore, polymerase, or a primer, is added into the flow cell, and based on the principle of complementary base pairing, the base with the fluorophore and the base on the nucleic acid sample to be tested are bound. Finally, the fluorophore is excited by an optical imaging system to generate fluorescence, the fluorescence is collected to form an image, and the base calling is conducted to achieve the base sequence determination of the nucleic acid sample to be tested.

To achieve the above process, how to establish a fluid connection that enables and/or blocks the flow of reagents into the flow cell is a technical issue worth paying attention to.

### SUMMARY

The present disclosure provides a carrier apparatus and a sequencing system.

The carrier apparatus according to the embodiments of the present disclosure includes a carrier platform, a fluid connecting assembly, and a movement mechanism. The carrier platform includes a table surface, the table surface being detachably connected to a flow cell assembly; the flow cell assembly includes a flow cell, with a fluid inlet and a fluid outlet being respectively formed at both ends of the flow cell. The fluid connecting assembly includes a manifold arranged in correspondence with the fluid inlet and the fluid outlet. The movement mechanism drives the fluid connecting assembly to move, including: when the fluid connecting assembly is located at a first position, the fluid connecting assembly and the flow cell assembly form a fluid communication through the manifold with the fluid inlet and the fluid outlet; and when the fluid connecting assembly is located at a second position, communication between the fluid connecting assembly and the flow cell assembly is cut off.

In the carrier apparatus according to the embodiments of the present disclosure, the fluid connecting assembly is driven by the movement mechanism to move relative to the flow cell assembly, such that the communication between the fluid connecting assembly and the flow cell assembly can be achieved or cut off. The carrier apparatus is simple in structure and convenient to operate.

The sequencing system according to the embodiments of the present disclosure includes the carrier apparatus.

In this way, the sequencing system facilitates the detection of the flow cell on the carrier apparatus, offering convenient operation, high sequencing efficiency, and high detection precision. Additional aspects and advantages of the present disclosure will be partially provided in the following description, will partially become apparent from the following description, or will be learned through the practice of the present disclosure.

### BRIEF DESCRIPTION OF THE DRAWINGS

The aforementioned and/or additional aspects and advantages of the present disclosure will become apparent and easily understood from the description of the embodiments with reference to the following drawings, in which:

FIG. 1 is a schematic structural diagram of a carrier apparatus according to embodiments of the present disclosure;

FIG. 2 is a schematic structural diagram of a carrier apparatus according to embodiments of the present disclosure;

FIG. 3 is a schematic structural diagram of a carrier apparatus according to embodiments of the present disclosure;

FIG. 4 is a schematic structural diagram of a carrier apparatus according to embodiments of the present disclosure;

FIG. 5 is a schematic structural diagram of a carrier apparatus according to embodiments of the present disclosure;

FIG. 6 is a schematic structural diagram of a flow cell assembly according to embodiments of the present disclosure;

FIG. 7 is a schematic structural diagram of a manifold according to embodiments of the present disclosure;

FIG. 8 is an enlarged schematic view of portion I of the carrier apparatus in FIG. 5;

FIG. 9 is a schematic structural diagram of a support member according to embodiments of the present disclosure;

FIG. 10 is a schematic diagram of the combination of a negative-pressure system and a carrier platform according to embodiments of the present disclosure;

FIG. 11 is a schematic structural diagram of a carrier apparatus according to other embodiments of the present disclosure;

FIG. 12 is an exploded view of a carrier apparatus in other embodiments of the present disclosure;

FIG. 13 is an exploded view of a thermostat assembly according to embodiments of the present disclosure;

FIG. 14 is a schematic structural diagram of a heat dissipation water tank according to some embodiments of the present disclosure;

FIG. 15 is a schematic structural diagram of a heat dissipation structure according to other embodiments of the present disclosure; and

FIG. 16 is an exploded view of a heat dissipation structure according to other embodiments of the present disclosure.

### DETAILED DESCRIPTION

The embodiments of the present disclosure are described in detail below, and the examples of the embodiments are shown in the accompanying drawings, throughout which identical or similar reference numerals represent identical or similar elements or elements having identical or similar functionality. The embodiments described below with reference to the drawings are exemplary and are merely intended to illustrate the present disclosure, but should not be construed as limiting the present disclosure.

In the description of the present disclosure, it should be understood that orientational or positional relationships indicated by terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, or “counterclockwise”, are those shown on the basis of the accompanying drawings, and are merely intended to facilitate and simplify the description rather than indicate or imply that the indicated device or element must have a specific orientation and be configured and operated according to the specific orientation. Such relationships should not be construed as limiting the present disclosure. In addition, the terms “first” and “second” are used herein for descriptive purposes only and should not be construed as indicating or implying relative importance or implicitly indicating the number of technical features described. Therefore, features defined with “first” and “second” may explicitly or implicitly include one or more of the features. In the description of the present disclosure, unless otherwise clearly and specifically defined, the term “plurality” means two or more.

In the description of the present disclosure, it should be noted that unless otherwise clearly specified and defined, the terms “mount”, “link”, and “connect” should be interpreted in their broad sense. For example, the connection may be a fixed connection, detachable connection, or integral connection; a mechanic connection, electric connection, or communicative connection; or a direct connection, indirect connection through an intermediate, internal communication of two elements, or interaction between two elements. For those of ordinary skill in the art, the specific meanings of the aforementioned terms in the present disclosure can be interpreted according to specific conditions.

In the present disclosure, unless otherwise explicitly stated or limited, a first feature being “above” or “below” a second feature may encompass that the first and second features are in direct contact and that the first and second features are not in direct contact but are in contact via an additional feature between them. Moreover, a first feature being “on”, “over”, and “above” a second feature includes that the first feature is right above or obliquely above the second feature, or simply means that the first feature is at a vertically higher position than the second feature. A first feature being “under”, “beneath”, and “below” a second feature includes that the first feature is right below or obliquely below the second feature, or simply means that the first feature is at a vertically lower position than the second feature.

The following disclosure provides many different embodiments or examples for implementing different structures of the present disclosure. To simplify the disclosure of the present application, the components and settings of specific examples are described below. Certainly, the examples are merely exemplary and are not intended to limit the present disclosure. In addition, reference numerals and/or characters may be repeatedly used in different examples in the present disclosure for simplicity and clarity rather than for indicating the relationship between various embodiments and/or settings discussed. In addition, the present disclosure provides examples of various specific processes and materials, but those of ordinary skill in the art will recognize the application of other processes and/or the use of other materials.

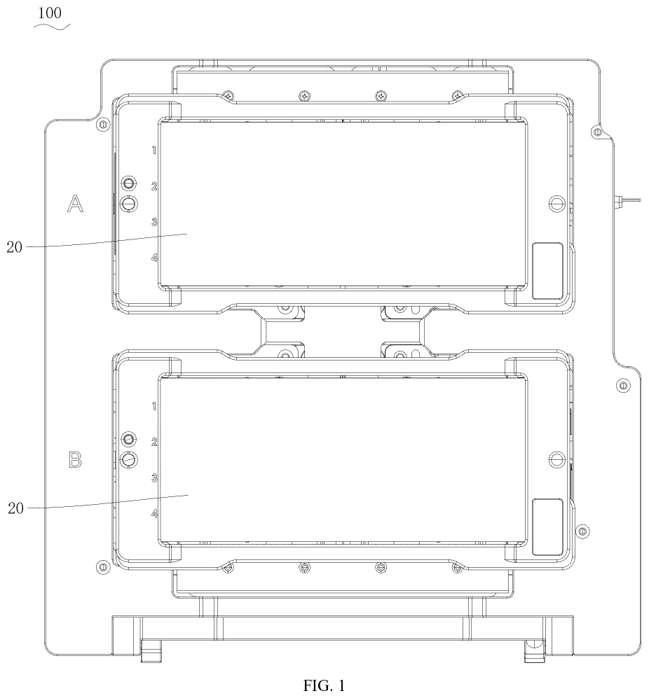

Referring to FIGS. 1 to 5, a carrier apparatus 100 according to the embodiments of the present disclosure includes a carrier platform 10, a fluid connecting assembly 30, and a movement mechanism 40. The carrier platform 10 includes a table surface 11, the flow cell assembly 20 is detachably connected to the table surface 11, the fluid connecting assembly 30 is connected to the movement mechanism 40, and the movement mechanism 40, when operating, drives the fluid connecting assembly 30 to move between a first position and a second position. When the fluid connecting assembly 30 is in the first position, the fluid connecting assembly 30 is in fluid communication with the flow cell assembly 20 on the table surface 11; when the fluid connecting assembly 30 is in the second position, the communication between the fluid connecting assembly 30 and the flow cell assembly 20 is cut off.

In the carrier apparatus 100 according to the embodiments of the present disclosure, the movement mechanism 40 drives the fluid connecting assembly 30 to move relative to the flow cell assembly 20, such that the communication between the fluid connecting assembly 30 and the flow cell assembly 20 can be achieved or cut off. The carrier apparatus 100 has a simple structure and is convenient to operate.

Specifically, the carrier platform 10 is configured to carry the flow cell assembly 20, the carrier platform 10 may be cuboid, the table surface 11 may be rectangular, and the size of the table surface 11 may be smaller than that of the flow cell assembly 20. The flow cell assembly 20 may be fixed on the table surface 11 by adopting a detachable connection mode such as negative pressure adsorption, magnetic attraction, adhesion, or snap-fit connection.

In some embodiments, the flow cell assembly 20 is detachably connected to the table surface 11, that is, the flow cell assembly 20 may be mounted on the table surface 11, or the flow cell assembly 20 may be removed from the table surface 11.

The fluid connecting assembly 30 may be located at both ends of the carrier platform 10 and on the side of the flow cell assembly 20 close to the carrier platform 10. The fluid connecting assembly 30 is movable relative to the flow cell assembly 20 to connect and disconnect from the flow cell assembly 20. When the fluid connecting assembly 30 is connected to the flow cell assembly 20, the fluid connecting assembly 30 forms fluid communication with the flow cell assembly 20; when the fluid connecting assembly 30 is disconnected from the flow cell assembly 20, communication between the fluid connecting assembly 30 and the flow cell assembly 20 is cut off. The first position is where the fluid connecting assembly 30 is located when the fluid connecting assembly 30 is connected to the flow cell assembly 20, and the second position is where the fluid connecting assembly 30 is located when the fluid connecting assembly 30 is disconnected from the flow cell assembly 20.

The movement mechanism 40 may be located on one side of the fluid connecting assembly 30 away from the flow cell assembly 20, the movement mechanism 40 may be a cam mechanism, a crank-slider mechanism, or a rack-and-pinion mechanism, and the movement mechanism 40 can drive the fluid connecting assembly 30 to perform a reciprocating linear motion between the first position and the second position.

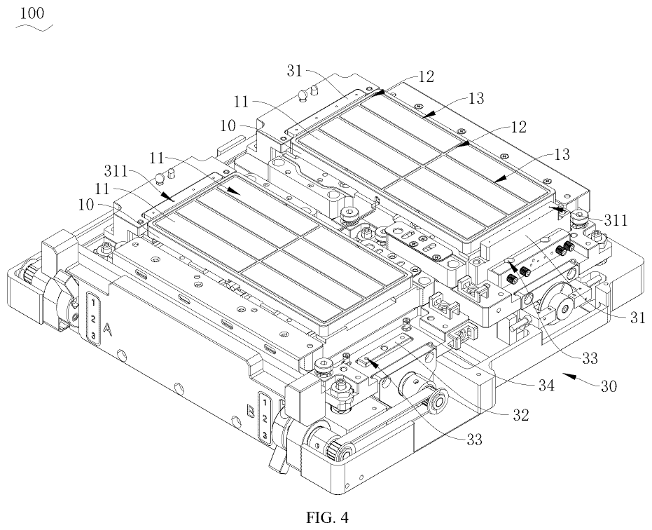

Referring to FIGS. 4 and 6, in some embodiments, the flow cell assembly 20 includes a flow cell 21, and a fluid inlet 22 and a fluid outlet 23 are respectively formed at both ends of the flow cell 21; the fluid connecting assembly 30 includes a manifold 31 arranged corresponding to the fluid inlet 22 and the fluid outlet 23. The fluid connecting assembly 30 and the flow cell assembly 20 form a fluid communication through the manifold 31 with the fluid inlet 22 and the fluid outlet 23.

In this way, the communication between the fluid connecting assembly 30 and the flow cell assembly 20 can be achieved by connecting the fluid inlet 22 and the fluid outlet 23 to the manifold 31, facilitating fluid communication.

Specifically, the flow cell 21 is configured to provide a site for biochemical reactions; the flow cell 21 may be a chip, and the flow cell 21 is provided with a space for accommodating liquid and thus can accommodate a target analyte, such that the target analyte undergoes biochemical reactions with the reaction liquid. The fluid inlet 22 and the fluid outlet 23 may be circular holes or square holes. There may be a plurality of fluid inlets 22 and fluid outlets 23, for example, two, three, or four. The plurality of fluid inlets 22 and the plurality of fluid outlets 23 are arranged in one-to-one correspondence.

The manifold 31 may be made of materials such as metal or plastic, and the manifold 31 may be formed by integral injection molding of two cuboids. The manifold 31 may include a plurality of fluid channels 311, and the plurality of fluid channels 311 are spaced apart from each other in a length direction of the manifold 31. The cross-sectional shape of the fluid channel 311 may be circular or square, and the fluid channel 311 may be bent. There may be a plurality of manifolds 31. The plurality of fluid channels 311 of part of the manifolds 31 are arranged in a one-to-one correspondence with the plurality of fluid inlets 22, and the plurality of fluid channels 311 of another part of the manifolds 31 are arranged in a one-to-one correspondence with the plurality of fluid outlets 23, such that the fluid can enter the flow cell 21 through the fluid channels 311 and the fluid inlets 22, and the fluid can also exit the flow cell 21 through the fluid channels 311 and the fluid outlets 23.

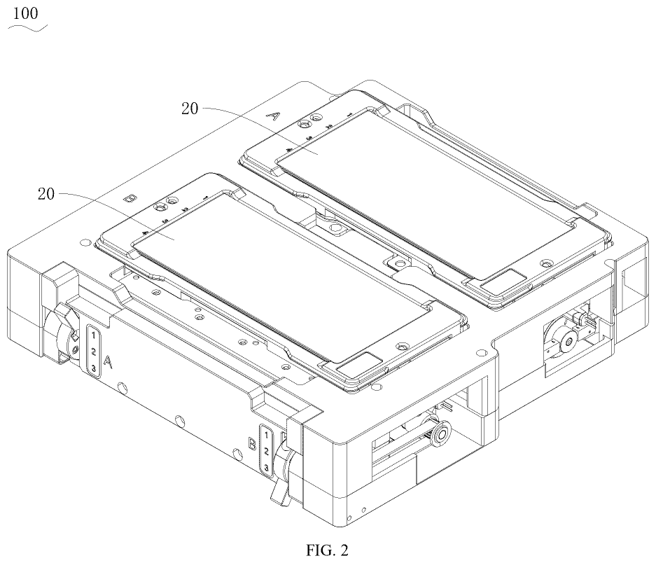

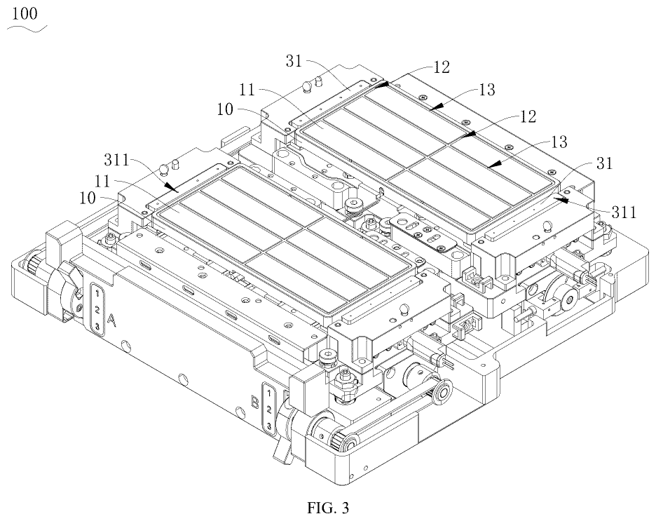

Referring to FIG. 2, a flow cell assembly 20 is placed on the table surface 11 of the carrier platform 10. Referring to FIGS. 3 and 4, the movement mechanism 40 drives the fluid connecting assembly 30 to move to the first position, which can be understood as the movement mechanism 40 driving the manifold 31 to move upward, such that the fluid channels 311 of part of the manifolds 31 communicate with the fluid inlets 22 of the flow cell 21, and the fluid channels 311 of part of the manifolds 31 communicate with the fluid outlets 23 of the flow cell 21. The movement mechanism 40 drives the fluid connecting assembly 30 to move to the second position, which can be understood as the movement mechanism 40 driving the manifold 31 to move downward, such that the fluid channels 311 of part of the manifolds 31 are away from the fluid inlets 22 of the flow cell 21, with the communication therebetween being cut off, and the fluid channels 311 of part of the manifolds 31 are away from the fluid outlets 23 of the flow cell 21, with the communication therebetween being cut off.

Referring to FIG. 4, in some embodiments, the fluid connecting assembly 30 includes a support member 32, and the manifold 31 is arranged on the support member 32.

In this way, the support member 32 can drive the manifold 31 to move between the first position and the second position, such that the communication between the manifold 31 and the flow cell 21 can be achieved or cut off.

Specifically, the support member 32 may have a T-shaped structure, the support member 32 and the manifold 31 may be fixedly connected by a fastener such as a bolt or a screw, and mounting holes 33 may be formed on the support member 32 and the manifold 31. The mounting hole 33 may be circular, and there may be a plurality of mounting holes 33, for example, two, three, or four. The plurality of mounting holes 33 are spaced apart from each other along the length direction of the support member 32 and extend along the height direction of the support member 32. Screws, bolts, or the like are screwed into the mounting holes 33. There may be a plurality of support members 32, and the plurality of support members 32 are arranged in a one-to-one correspondence with the plurality of manifolds 31.

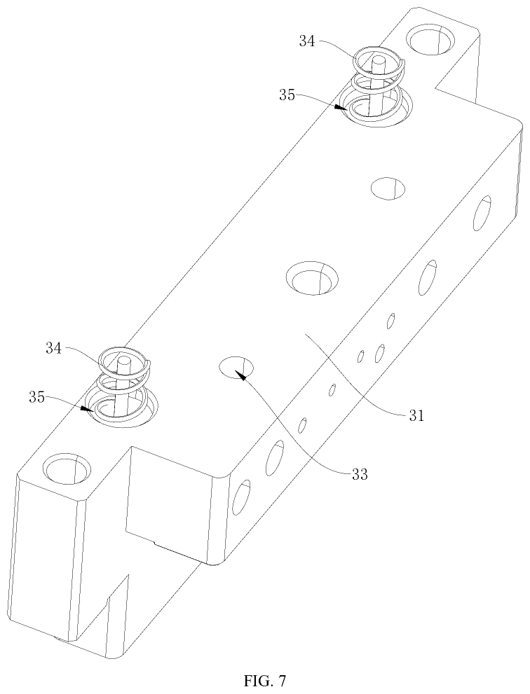

Referring to FIGS. 4 and 7, in some embodiments, the fluid connecting assembly 30 includes an elastic member 34. The elastic member 34 is connected to the manifold 31, and the elastic member 34 is configured to maintain the manifold 31 in a tendency to move toward the flow cell 21.

In this way, the elastic member 34 can provide an elastic force to buffer the impact force between the flow cell 21 and the manifold 31, and at the same time, the elastic member 34 can provide an elastic force to drive the manifold 31 to abut against the flow cell 21, so as to ensure the sealing performance between the flow cell 21 and the manifold 31.

Specifically, the elastic member 34 may be a spring or other elastic elements; a groove 35 may be formed on the manifold 31, and the shape of the groove 35 may be circular. There may be a plurality of grooves 35, for example, two, three, or four. The plurality of grooves 35 are spaced apart from each other along the length direction of the manifold 31 and extend along the height direction of the manifold 31, and one end of the elastic member 34 abuts against the groove 35.

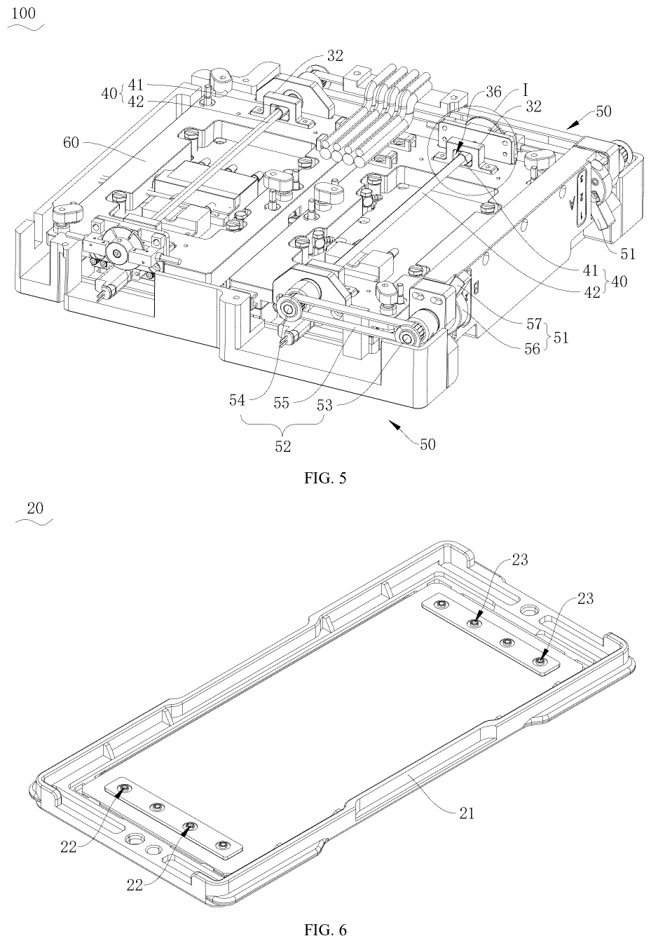

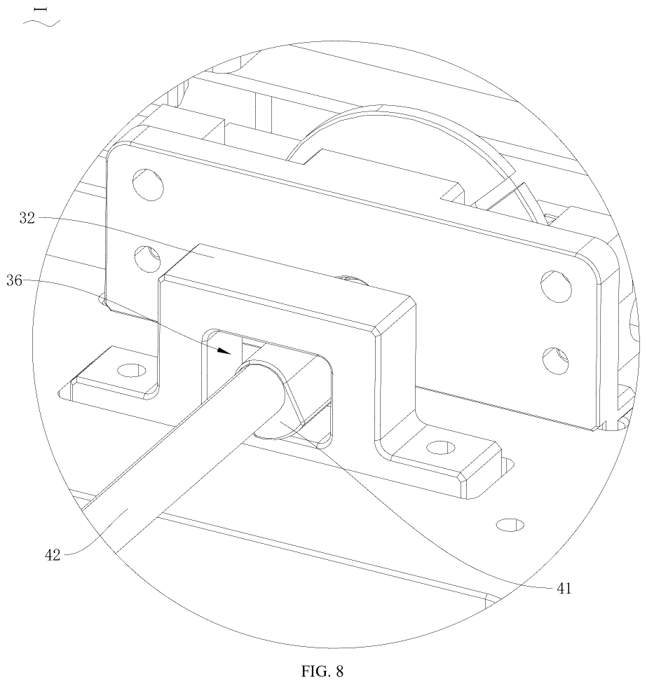

Referring to FIGS. 5 and 8, in some embodiments, the movement mechanism 40 includes a cam 41 and a rotation shaft 42. The cam 41 is connected to the rotation shaft 42, and the rotation shaft 42 is capable of driving the cam 41 to rotate. The cam 41 is further connected to the support member 32, and the cam 41, when rotating, drives the manifold 31 on the support member 32 to move to the first position or the second position.

In this way, the rotation of the rotation shaft 42 can drive the cam 41 to rotate, thereby moving the support member 32 and the manifold 31, such that the communication between the manifold 31 and the flow cell 21 can be achieved or cut off.

Specifically, the cam 41 may be a member with a curved contour, and the cam 41 may rotate clockwise or counterclockwise along with the rotation shaft 42 around the central axis of the rotation shaft 42. The rotation shaft 42 may be a circular shaft body, and there may be a plurality of cams 41, for example, two, three, or four. The plurality of cams 41 are arranged in a one-to-one correspondence with the plurality of support members 32. The size of the cam 41 may be designed according to the relative distance between the first position and the second position.

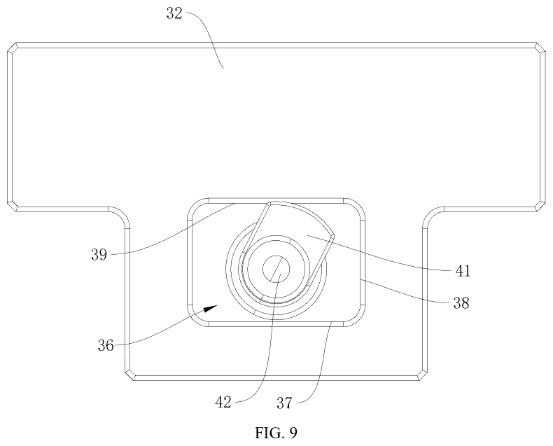

Referring to FIGS. 5 and 9, in some embodiments, a limiting hole 36 is formed on the support member 32, the cam 41 is arranged in the limiting hole 36, and the limiting hole 36 cooperates with the cam 41, such that the cam 41, when rotating, is capable of driving the manifold 31 on the support member 32 to move to the first position or the second position.

In this way, the cam 41 is arranged in the limiting hole 36, which can limit the movement range of the support member 32 and thus limit the movement range of the manifold 31, such that the manifold 31 can move between the first position and the second position, and the communication between the manifold 31 and the flow cell 21 can be achieved or cut off.

Specifically, the shape of the limiting hole 36 may be square or circular, and the size of the limiting hole 36 may be designed according to the size of the cam 41, such that the cam 41 can rotate in the limiting hole 36 and drive the support member 32 to move. There may be a plurality of limiting holes 36, and the plurality of limiting holes 36 are arranged in a one-to-one correspondence with the plurality of cams 41.

Referring to FIGS. 5 and 9, in some embodiments, the limiting hole 36 is square and includes a first inner wall 37 and a second inner wall 38; when the cam 41 abuts against the first inner wall 37, the cam 41 drives the manifold 31 to move away from the flow cell 21; when the cam 41 abuts against the second inner wall 38, the cam 41 drives the manifold 31 to move close to the flow cell 21.

In this way, the cam 41 abutting against the first inner wall 37 and the second inner wall 38 can limit the movement range of the support member 32 and thus the movement range of the manifold 31, such that the manifold 31 can move between the first position and the second position, and the communication between the manifold 31 and the flow cell 21 can be achieved or cut off.

Specifically, the included angle formed between the first inner wall 37 and the second inner wall 38 may be 90°; the first inner wall 37 may be parallel to the table surface 11, and the second inner wall 38 may be perpendicular to the table surface 11. The size of the first inner wall 37 and the second inner wall 38 may be designed according to the size of the cam 41.

Referring to FIGS. 5 and 9, in some embodiments, the limiting hole 36 includes a third inner wall 39. The third inner wall 39 is arranged opposite the first inner wall 37 and arranged closer to the manifold 31 than the first inner wall 37; when the cam 41 abuts against the third inner wall 39, the cam 41 drives the manifold 31 to move close to the flow cell 21. In this way, the cam 41 abutting against the third inner wall 39 can limit the movement range of the support member 32 and thus the movement range of the manifold 31, such that the manifold 31 can move between the first position and the second position, and the communication between the manifold 31 and the flow cell 21 can be achieved or cut off. In addition, when the elastic member 34 cannot provide an elastic force to drive the manifold 31 to abut against the flow cell 21, the cam 41 abuts against the third inner wall 39, such that the manifold 31 can be driven to abut against the flow cell 21, thus ensuring the sealing performance between the flow cell 21 and the manifold 31.

Specifically, the included angle formed between the third inner wall 39 and the second inner wall 38 may be 90°; the third inner wall 39 may be parallel to the first inner wall 37. The size of the third inner wall 39 may be consistent with the size of the first inner wall 37. Referring to FIG. 5, in some embodiments, the carrier apparatus 100 includes a driving mechanism 50. The driving mechanism 50 is configured to drive the rotation shaft 42 to rotate. In this way, the driving mechanism 50 can drive the rotation shaft 42 to rotate, which in turn drives the cam 41 to rotate, thereby driving the support member 32 and the manifold 31 to move, such that the communication between the manifold 31 and the flow cell 21 is achieved or cut off.

Specifically, the driving mode of the driving mechanism 50 includes, but is not limited to, manual drive, electric drive, pneumatic drive, and hydraulic drive. The driving mechanism 50 may be a cylinder assembly or a motor assembly, such as the cooperation of a motor and a lead screw, or the cooperation of a motor and a belt. The driving mechanism 50 may be connected to the rotation shaft 42 by fasteners such as bolts or screws.

Referring to FIG. 5, in some embodiments, the driving mechanism 50 includes a driving member 51 and a transmission assembly 52. The transmission assembly 52 connects the driving member 51 with the rotation shaft 42, and the driving member 51 is configured to drive the rotation shaft 42 to rotate through the transmission assembly 52.

In this way, the driving member 51 drives the rotation shaft 42 to rotate through the transmission assembly 52, which in turn drives the cam 41 to rotate, thereby driving the support member 32 and the manifold 31 to move, such that the communication between the manifold 31 and the flow cell 21 is achieved or cut off.

Specifically, the driving member 51 may be a motor or a cylinder, and the driving member 51 may drive the transmission assembly 52 to move, thereby driving the rotation shaft 42 to rotate. The transmission assembly 52 may be fixedly connected to the driving member 51 and the rotation shaft 42 by fasteners such as bolts or screws.

Referring to FIG. 5, in some embodiments, the transmission assembly 52 includes a first synchronous pulley 53, a second synchronous pulley 54, and a synchronous belt 55. The first synchronous pulley 53 is connected to the driving member 51, the second synchronous pulley 54 is connected to the rotation shaft 42, and the synchronous belt 55 is wound around the first synchronous pulley 53 and the second synchronous pulley 54.

In this way, the transmission assembly 52 can cause the rotation shaft 42 to rotate, which in turn drives the cam 41 to rotate relative to the flow cell 21, thereby enabling the manifold 31 to fluidly connect with and disconnect from the flow cell 21.

Specifically, the first synchronous pulley 53 and the second synchronous pulley 54 may be made of materials such as steel, aluminum alloy, cast iron, or brass. The inner holes of the first synchronous pulley 53 and the second synchronous pulley 54 may be circular holes, D-shaped holes, or tapered holes. The inner circumferential surface of the synchronous belt 55 is provided with teeth that are evenly spaced to match the first synchronous pulley 53 and the second synchronous pulley 54. During motion, the teeth of the synchronous belt 55 engage with the tooth grooves of the first synchronous pulley 53 and the second synchronous pulley 54 to transmit motion and power. By setting the tooth count ratio of the first synchronous pulley 53 and the second synchronous pulley 54, the rotation speed ratio of the second synchronous pulley 54 and the first synchronous pulley 53 can be adjusted.

After the driving member 51 is started, the driving member 51 drives the first synchronous pulley 53 to rotate; the tooth grooves of the first synchronous pulley 53 engage with the teeth of the synchronous belt 55, and the first synchronous pulley 53 rotates to drive the synchronous belt 55 to move; the teeth of the synchronous belt 55 engage with the tooth grooves of the second synchronous pulley 54, and the synchronous belt 55 moves to drive the second synchronous pulley 54 to rotate; the second synchronous pulley 54 is coaxially arranged with the rotation shaft 42, and the second synchronous pulley 54 rotates to drive the rotation shaft 42 to rotate.

Referring to FIG. 5, in some embodiments, the driving member 51 is a manual driving member and includes a rotation part 56 and an operation part 57 connected to the rotation part 56. The rotation part 56 is connected to the first synchronous pulley 53.

In this way, with the use of a manual driving member, the rotation of the rotation part 56 and the first synchronous pulley 53 can be manually adjusted, and the communication between the fluid connecting assembly 30 and the flow cell assembly 20 can be manually controlled, thereby achieving precise fluid control, with a simple structure, convenient operation, and low manufacturing and maintenance costs.

Specifically, the rotation part 56 may be a cylinder, and the rotation part 56 extends outward along a diameter direction to form the operation part 57. The operation part 57 may be a cuboid. The rotation part 56 and the operation part 57 may be integrally formed or fixedly connected by welding. The rotation part 56 is coaxially arranged with the first synchronous pulley 53, and the operation part 57 is manually operated to drive the rotation part 56 to rotate, thereby driving the first synchronous pulley 53 to rotate.

Referring to FIGS. 3 and 5, in some embodiments, there are a plurality of carrier platforms 10, a plurality of movement mechanisms 40, and a plurality of driving mechanisms 50, and the plurality of carrier platforms, the plurality of movement mechanisms, and the plurality of driving mechanisms are arranged in one-to-one correspondence; the driving members 51 of the plurality of driving mechanisms 50 are arranged on the same side of the carrier apparatus 100.

In this way, there are a plurality of carrier platforms 10, a plurality of movement mechanisms 40, and a plurality of driving mechanisms 50, such that a plurality of flow cells 21 can be fixed simultaneously. This facilitates the sequencing of test samples on the plurality of flow cells 21 simultaneously, thereby improving sequencing efficiency. In addition, the driving members 51 of the plurality of driving mechanisms 50 are arranged on the same side of the carrier apparatus 100, which can reduce the space occupied by the driving members 51. This makes the structure of the carrier apparatus 100 compact, thereby improving the space utilization of the carrying apparatus 100 and reducing the volume of the carrying apparatus 100.

Specifically, there may be two carrier platforms 10, two movement mechanisms 40, and two driving mechanisms 50, and there may also be two flow cell assemblies 20 and two fluid connecting assemblies 30. The two carrier platforms 10 may simultaneously fix the two flow cells 21, so as to facilitate simultaneous processing and imaging of the two flow cells 21. The two driving mechanisms 50 respectively drive the two movement mechanisms 40 to move, thereby driving the two fluid connecting assemblies 30 to move relative to the two flow cells 21, and thus achieving independent control of the two fluid connecting assemblies 30 and the two flow cells 21.

Referring to FIGS. 3 and 5, in some embodiments, the carrier apparatus 100 includes a mounting platform 60. The carrier platform 10 and the movement mechanism 40 are respectively arranged on both sides of the mounting platform 60, and the support member 32 is arranged to pass through the mounting platform 60.

In this way, the mounting platform 60 is fixedly connected with the carrier platform 10, the movement mechanism 40, and the support member 32, which can improve the stability of the carrier apparatus 100 and thus improve the stability of the flow cell 21, thereby improving the sequencing accuracy.

Specifically, the shape of the mounting platform 60 may be a cuboid, and the movement mechanism 40 may drive the support member 32 to move in the height direction relative to the mounting platform 60. There may be two mounting platforms 60, and the two mounting platforms 60 are arranged in a one-to-one correspondence with the two carrier platforms 10 and the two movement mechanisms 40.

Referring to FIG. 3, in some embodiments, adsorption groove channels 2111 are formed on the table surface 11 of the carrier platform 10, and the adsorption groove channels 2111 are evenly distributed on the table surface 11; the carrier apparatus 100 further includes a negative-pressure system 300, and the negative-pressure system 300 communicates with the adsorption groove channels 2111.

Referring to FIG. 3, the adsorption groove channels 2111 include at least one first groove channel 12 and at least one second groove channel 13, and the first groove channel 12 communicates with the second groove channel 13.

In this way, the arrangement of at least one first groove channel 12 and at least one second groove channel 13 to communicate with each other enables the formation of a plurality of openings on the table surface 11 for the adsorption of the flow cell 21, thereby fixing the flow cell 21 onto the table surface 11.

Specifically, there may be one, two, three, or four first groove channels 12 and second groove channels 13. When there are a plurality of first groove channels 12 and a plurality of second groove channels 13, the adsorption range of the table surface 11 can be further increased, thereby improving the stability of the carrier apparatus 100 in adsorbing the flow cell 21. The cross-sectional shapes of the first groove channel 12 and the second groove channel 13 may be rectangular or arc-shaped.

Referring to FIG. 3, in some embodiments, the first groove channel 12 and the second groove channel 13 are crosswise arranged.

In this way, the crosswise arrangement of the first groove channel 12 and the second groove channel 13 can increase the coverage of the first groove channel 12 and the second groove channel 13 on the table surface 11, which is suitable for flow cells 21 of different sizes, and improves the absorption effect of the carrier apparatus 100.

Specifically, the included angle between the first groove channel 12 and the second groove channel 13 may be an acute angle, a right angle, or an obtuse angle.

Referring to FIG. 3, in some embodiments, there are a plurality of first groove channels 12, and the plurality of the first groove channels 12 are spaced apart and arranged in parallel; there are a plurality of second groove channels 13, and the plurality of second groove channels 13 are spaced apart and arranged in parallel. The first groove channels 12 are perpendicular to the second groove channels 13.

In this way, the plurality of first groove channels 12 and the plurality of second groove channels 13 are arranged to cross each other perpendicularly, such that the first groove channels 12 and the second groove channels 13 can form a mesh-like layout of openings on the table surface 11. When the flow cell 21 is placed on the table surface 11, the flow cell 21 can be absorbed and fixed through a negative pressure generated at the openings of the first groove channels 12 and the second groove channels 13.

Specifically, there may be three, four, or five first groove channels 12, and there may be five, six, or seven second groove channels 13. The first groove channels 12 may be parallel to the length direction of the table surface 11, and the second groove channels 13 may be parallel to the width direction of the table surface 11. Alternatively, the first groove channels 12 may be parallel to the width direction of the table surface 11, and the second groove channels 13 may be parallel to the length direction of the table surface 11.

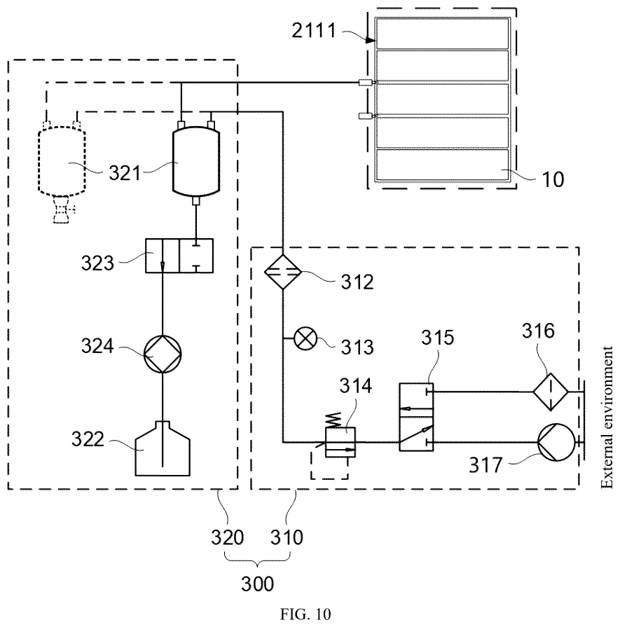

Referring to FIG. 10, the negative-pressure system 300 includes a negative-pressure assembly 310. The negative-pressure assembly 310 is configured to generate negative pressure within the adsorption groove channel 2111, and the negative-pressure assembly 310 includes a first pump 311 and a first valve 315. The first valve 315 is configured to switch between a first operating state and a second operating state. When the first valve 315 is in the first operating state, the first valve 315 communicates with the first pump 311 and the adsorption groove channel 2111; when the first valve 315 is in the second operating state, the communication between the first pump 311 and the adsorption groove channel 2111 is cut off, and the first valve 315 communicates the adsorption groove channel 2111 with the external atmosphere.

In the carrier apparatus 100 of the embodiment, by arranging a carrier platform 10 with adsorption groove channels 2111 to cooperate with a negative-pressure system 300, negative pressure can be generated at the adsorption groove channels 2111 to adsorb and fix the flow cell 21, and the flow cell 21 can be separated when the negative pressure is removed. This structure is simple and allows for easy assembly and disassembly.

Specifically, referring to FIG. 10, the first valve 315 communicates with the adsorption groove channel 2111 through a first conduit on which a first filter 312 is arranged.

When using the carrier apparatus 100 of the embodiment, the flow cell 21 is placed on the carrier platform 10 first to ensure that the flow cell 21 covers the adsorption groove channels 2111; the first pump 311 is started to pump air to generate negative pressure at the adsorption groove channels 2111; in the air pumping process of the first pump 311, the first filter 312 can filter the air in the air path between the first pump 311 and the adsorption groove channels 2111, so as to prevent external substances from entering the first pump 311, thereby ensuring the operational reliability of the first pump 311.

Further, referring to FIG. 10, the first valve 315 communicates with the external atmosphere through a second conduit on which a second filter 316 is arranged.

In the embodiment, by arranging the first valve 315 to cooperate with the first pump 311 and the second filter 316, respectively, the first valve 315 can be switched to control the communication and disconnection between the pump 311 and the second filter 316. When the pump 311 is in communication, the pump 311 can drive the generation of negative pressure at the adsorption groove channel 2111; when the second filter 316 is in communication, air can be introduced through the second filter 316 to balance the internal air pressure of the second conduit.

Specifically, the first valve 315 is a two-position three-way solenoid valve, and the two output ports of the first valve 315 communicate with the first pump 311 and the second filter 316, respectively. The first valve 315 is configured to switch the input port of the first valve 315 to communicate with the two output ports, respectively.

It can be understood that the use of a two-position three-way solenoid valve to connect the first pump 311 and the second filter 316 enables the first valve 315 to switch rapidly according to electric signals. When the carrier apparatus 100 has an automatic control function, an automatic switching control function of the carrier apparatus 100 can be achieved.

Further, referring to FIG. 10, the negative-pressure assembly 310 further includes a pressure detection member 313. The pressure detection member 313 is connected to an air pipeline, and the pressure detection member 313 is configured to detect the air pressure of the negative-pressure system 300.

With such an arrangement, the pressure detection member 313 can acquire air pressure signals of the air pipeline within the negative-pressure assembly 310 in real-time, such that an operator can manually, or the carrier apparatus 100 can automatically, regulate the air pressure within the air pipeline. Specifically, the pressure detection member 313 includes, but is not limited to, a physical barometer or an electronic barometer.

Further, referring to FIG. 10, the negative-pressure system 300 further includes a gas-water separation assembly 320. The gas-water separation assembly 320 communicates with the negative-pressure assembly 310 and the adsorption groove channel 2111, the negative-pressure assembly 310 is configured to generate negative pressure, and the gas-water separation assembly 320 is configured to separate gas and liquid within the negative-pressure system 300.

By arranging the gas-water separation assembly 320 to cooperate with the negative-pressure assembly 310, the gas and liquid within the negative-pressure system 300 can be separated, preventing the liquid from affecting the operation of the negative-pressure assembly 310, thereby increasing the operational reliability of the carrier apparatus 100.

In some embodiments, referring to FIG. 10, the negative-pressure assembly 310 further includes a second valve 314. The second valve 314 is a negative pressure regulating valve 314, the negative pressure regulating valve 314 is connected to the air pipeline, and the negative pressure regulating valve 314 is configured to regulate the air pressure within the air pipeline.

In the embodiment, the arrangement of a negative pressure regulating valve 314 in the air pipeline of the negative-pressure assembly 310 enables the negative pressure regulating valve 314 to regulate the air pressure inside the air pipeline, such that the negative-pressure assembly 310 operates in a preset air pressure state.

Specifically, referring to FIG. 10, the gas-water separation assembly 320 includes a gas-water separator 321 and a waste liquid tank 322. The input port of the gas-water separator 321 communicates with the adsorption groove channel 2111, the liquid outlet of the gas-water separator 321 communicates with the waste liquid tank 322, and an air outlet of the gas-water separator 321 communicates with the negative-pressure assembly 310.

When using the carrier apparatus 100 of the embodiment, the mixed gas output from the adsorption groove channel 2111 firstly enters the gas-water separator 321, and the gas and liquid are separated through the gas-water separator 321; the negative-pressure assembly 310 can pump and output the gas to prevent the liquid from contacting the negative-pressure assembly 310, which could lead to a malfunction of the negative-pressure assembly 310; the liquid can be output to the waste liquid tank 322 through the gas-water separator 321 for storage. Certainly, in some embodiments, the waste liquid tank 322 may not be arranged, and the liquid output from the gas-water separator 321 is directly discharged to the sewer through a conduit.

In an embodiment, referring to FIG. 10, the gas-water separation assembly 320 further includes a third valve 323. The third valve 323 communicates with the gas-water separator 321 and the waste liquid tank 322; the third valve 323 is a two-position two-way solenoid valve or a manual valve.

It can be understood that the use of a third valve 323 to control the communication and disconnection between the gas-water separator 321 and the waste liquid tank 322 enables the regulation of the communication and disconnection between the two according to the situation. When a two-position two-way solenoid valve is used, the third valve 323 can rapidly switch the communication or disconnection between the gas-water separator 321 and the waste liquid tank 322 according to electric signals, enabling an automatic control function; when a manual valve is used, the third valve 323 can be manually opened or closed.

Further, referring to FIG. 10, the gas-water separation assembly 320 further includes a second pump 324. The second pump 324 communicates with the gas-water separator 321 and the waste liquid tank 322, respectively, and the second pump 324 is configured to drive the liquid within the gas-water separator 321 toward the waste liquid tank 322 for conveyance.

With such an arrangement, the second pump 324 can be started to pump the liquid within the gas-water separator 321 toward the waste liquid tank 322 for conveyance, thereby increasing the liquid discharge efficiency of the gas-water separation assembly 320.

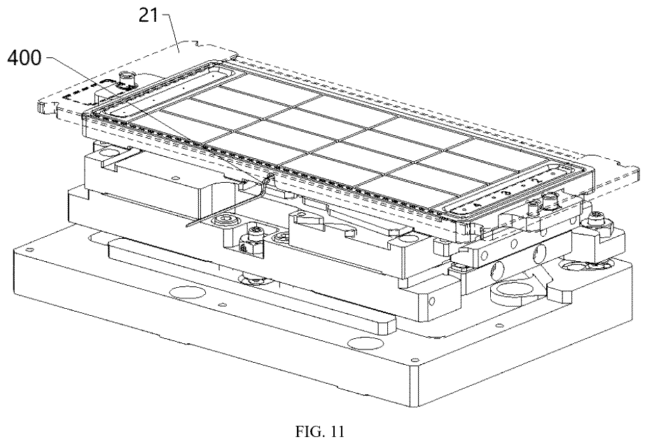

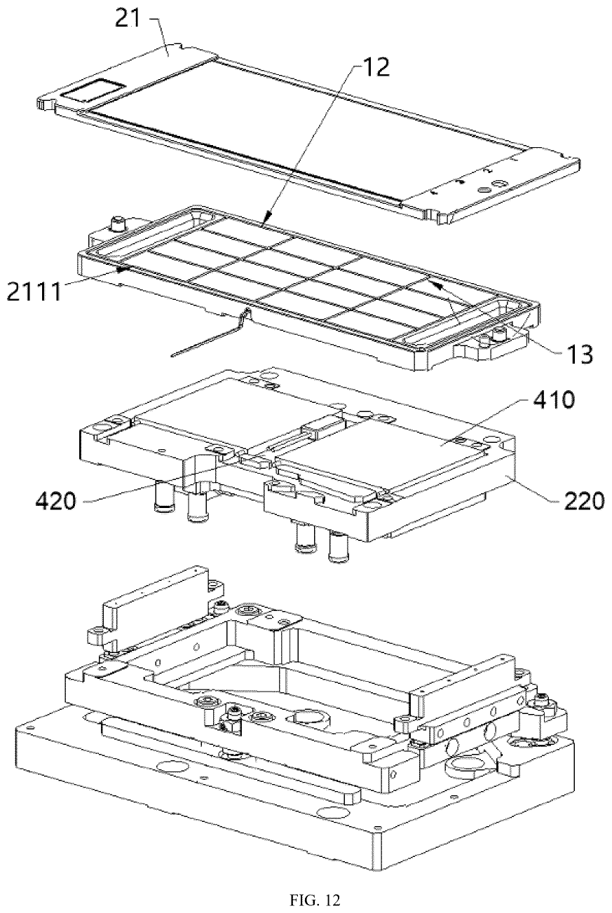

Specifically, referring to FIGS. 11 and 12, the carrier apparatus 100 further includes a thermostat assembly 400. The thermostat assembly 400 is connected to the carrier platform 10, and the thermostat assembly 400 is at least partially in contact with the carrier platform 10 and exchanges heat with the carrier platform 10.

In the carrier apparatus 100 of the embodiment, by arranging the carrier platform 10 with adsorption groove channels 2111 to cooperate with a flow cell 21, and connecting the adsorption groove channels 2111 to the negative-pressure system 300, negative pressure can be generated at the openings of the adsorption groove channels 2111 on the table surface 11, that is, the flow cell 21 can be fixed onto the carrier platform 10, providing a good fixing effect and effectively solving the problem of damage to the flow cell 21 caused by the press-snapping method of fixing the flow cell 21 in existing gene sequencers. Subsequently, the reaction temperature of the flow cell 21 can be controlled through the cooperation of the thermostat assembly 400 and the carrier platform 10, achieving a good using effect.

Specifically, referring to FIG. 12, the carrier apparatus 100 further includes a heat insulation plate 220. The heat insulation plate 220 encloses the thermostat assembly 400, and the heat insulation plate 220 is connected to the carrier platform 10. The thermostat assembly 400 includes a thermoelectric cooler 410 and a heat dissipation structure 420. The thermoelectric cooler 410 is connected between the heat dissipation structure 420 and the carrier platform 10, and the heat dissipation structure 420 is configured to conduct the heat of the thermoelectric cooler 410.

In addition, by arranging the heat insulation plate 220 to cooperate with the thermostat assembly 400 and the carrier platform 10, the heat insulation plate 220 can protect the thermostat assembly 400 by not only preventing the thermostat assembly 400 from being damaged by external bumps but also preventing the intense heat inside the thermostat assembly 400 from harming the operator. Consequently, the safety and durability during the use of the carrier apparatus 100 are improved. Preferably, a through groove may be formed inside the heat insulation plate 220, the carrier platform 10 is arranged to cover one side of the through groove, and the thermostat assembly 400 is accommodated in the through groove and protected by the heat insulation plate 220.

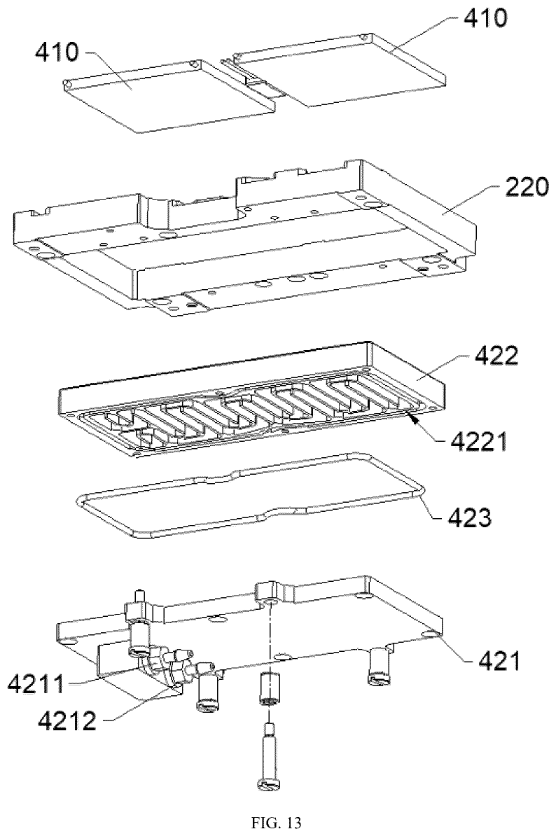

Specifically, referring to FIG. 13, the heat dissipation structure 420 includes a heat dissipation cover plate 421 and a heat dissipation water tank 422. A heat dissipation flow channel is formed inside the heat dissipation water tank 422, and the heat dissipation cover plate 421 is detachably connected to the heat dissipation water tank 422 and covers the heat dissipation flow channel; the heat dissipation flow channel is configured to convey a cooling liquid and conduct heat, and a liquid inlet hole 4211 and a liquid outlet hole 4212 that respectively communicate with the heat dissipation flow channel are formed on the heat dissipation cover plate 421.

When assembling the heat dissipation structure 420 of the embodiment, the heat dissipation cover plate 421 and the heat dissipation water tank 422 may be hermetically connected using methods such as bonding, screw connection, or welding, and as the two are combined using a detachable connection method, the processing of the heat dissipation flow channel on the heat dissipation water tank 422 is facilitated. When maintenance is needed in the future, the mere replacement of the heat dissipation cover plate 421 or the heat dissipation water tank 422 could satisfy the maintenance requirement, and the cost of use is therefore reduced.

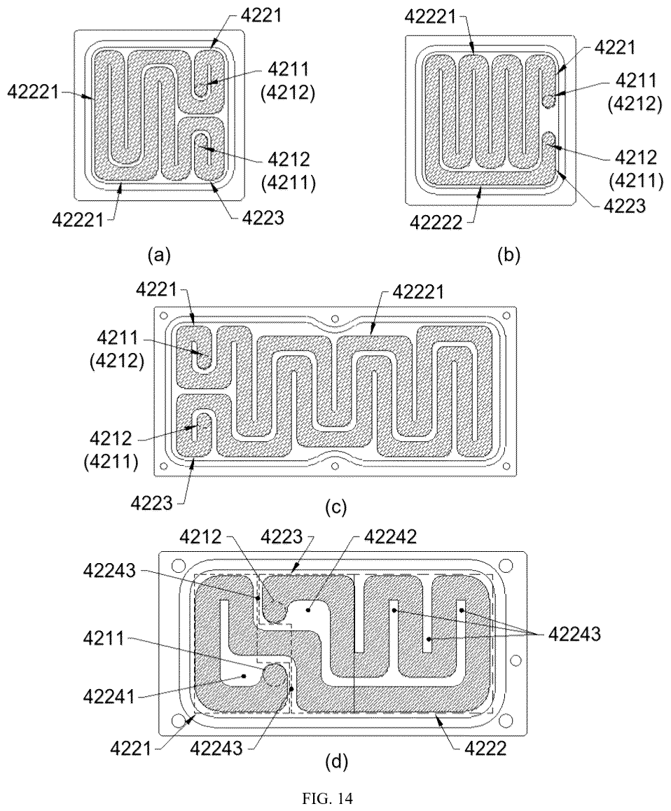

Specifically, referring to FIGS. 13 to 14, a liquid inlet hole 4211 and a liquid outlet hole 4212 that communicate with the heat dissipation flow channel are formed in the heat dissipation structure 420. Specifically, the heat dissipation flow channel includes a first flow channel 4221, an intermediate flow channel 4222, and a second flow channel 4223. The first flow channel 4221 communicates with the liquid inlet hole 4211; the intermediate flow channel 4222 communicates with the first flow channel 4221 and is located on one side of the first flow channel 4221; the second flow channel 4223 communicates with the intermediate flow channel 4222 and the liquid outlet hole 4212, respectively, and the second flow channel 4223 is located on one side of the intermediate flow channel 4222 facing the first flow channel 4221. The liquid inlet hole 4211 and the liquid outlet hole 4212 are respectively formed on the same side of the heat dissipation structure 420, the first flow channel 4221 and the second flow channel 4223 are symmetrically arranged, and the orthographic projection of the heat dissipation flow channel on the heat dissipation structure 420 is evenly distributed within the heat dissipation structure 420.

In the heat dissipation structure 420 of the embodiment, by disposing the first flow channel 4221 and the second flow channel 4223 on the same side of the intermediate flow channel 4222, the length of the cooling liquid's flow path within the heat dissipation flow channel can be increased as much as possible, thereby improving the heat dissipation effect of the heat dissipation structure 420. Meanwhile, by disposing the liquid inlet hole 4211 and the liquid outlet hole 4212 on the same side of the heat dissipation structure 420, the overall structural layout of the heat dissipation structure 420 can be facilitated.

In an embodiment, the intermediate flow channel 4222 includes at least one curved section 42221, and the curved section 42221 is arranged in a curved manner within the heat dissipation structure 420, such that the intermediate flow channel 4222 forms a comb-shaped flow channel inside the heat dissipation structure 420.

In the embodiment, the curved section 42221 is in a zigzag shape and is repeatedly bent, such that the internal structure of the heat dissipation structure 420 forms a mutually staggered blocking structure. The cooperation of the blocking structure and the intermediate flow channel 4222 causes the formation of a flow channel with a comb-shaped structure inside the heat dissipation structure 420. With such an arrangement, the coverage of the heat dissipation flow channel on the orthographic projection of the heat dissipation structure 420 can be increased, thereby improving the heat dissipation efficiency of the heat dissipation structure 420.

In another embodiment, the intermediate flow channel 4222 further includes a connecting section 42222; one end of the connecting section 42222 communicates with the curved section 42221, and the other end of the connecting section 42222 communicates with the first flow channel 4221 or the second flow channel 4223; the connecting section 42222 is arranged in a straight line direction and attached to one side of the curved section 42221.

In the embodiment, by arranging the connecting section 42222 to connect with the curved section 42221, the flow rate of the cooling liquid within the connecting section 42222 can be increased, such that the heat inside the heat dissipation structure 420 can be conducted more quickly and evenly to other low-temperature portions of the heat dissipation structure 420, thereby improving the heat conduction effect of the heat dissipation structure 420.

In yet another embodiment, the first flow channel 4221 is at least partially arranged in a curved manner, and the orthographic projection of the liquid inlet hole 4211 on the heat dissipation structure 420 is at least partially located on the inner side of the first flow channel 4221; and/or the second flow channel 4223 is at least partially arranged in a curved manner, and the orthographic projection of the liquid inlet hole 4211 on the heat dissipation structure 420 is at least partially located on the inner side of the second flow channel 4223.

By arranging the first flow channel 4221 to at least partially surround the liquid inlet hole 4211, when the heat dissipation structure 420 conducts heat with an external heat source (i.e., an object to be cooled), the cooling liquid enters the first flow channel 4221 through the liquid inlet hole 4211, which can increase the length of the cooling liquid's flow path within the first flow channel 4221, thereby increasing the heat received by the cooling liquid. Moreover, as the first flow channel 4221 is arranged around the liquid inlet hole 4211, the overlapping area between the orthographic projection of the first flow channel 4221 on the heat dissipation structure 420 and the external heat source can be increased, such that the heat conduction effect and the heat dissipation effect of the heat dissipation structure 420 are further improved. Meanwhile, by arranging the first flow channel 4221 to at least partially surround the liquid inlet hole 4211, the overall structure of the first flow channel 4221 and the liquid inlet hole 4211 can be made more compact, which helps satisfy the compact design requirement of the heat dissipation structure 420. Likewise, by arranging the second flow channel 4223 around the liquid outlet hole 4212, the length of the cooling liquid's flow path within the second flow channel 4223 can be increased, thereby increasing the heat output by the cooling liquid. Meanwhile, the overlapping area between the second flow channel 4223 and the external heat source can also be increased, and the overall structure of the second flow channel 4223 and the liquid outlet hole 4212 are also made compact, which will not be elaborated herein.

It should be noted that the term “orthographic projection” herein refers to an orthographic projection of the heat dissipation flow channel on the heat dissipation structure 420 in a direction perpendicular to the hot surface of the heat dissipation structure 420. The projection method is shown in FIG. 14. In the embodiment, the heat dissipation structure 420 is provided with a flat surface configured to contact an external member to achieve a heat dissipation effect. The orthographic projection of the liquid inlet hole 4211 on the heat dissipation structure 420 is at least partially located on the inner side of the first flow channel 4221, and the orthographic projection of the liquid outlet hole 4212 on the heat dissipation structure 420 is at least partially located on the inner side of the second flow channel 4223, such that the heat dissipation flow channel can have a longer path to surround the liquid inlet hole 4211 and the liquid outlet hole 4212, thus increasing the heat exchange between the cooling liquid and the heat dissipation structure 420, thereby improving the heat dissipation effect of the heat dissipation structure 420.

Specifically, referring to FIG. 14(a), in Embodiment I, the intermediate flow channel 4222 includes at least two curved sections 42221, and the two curved sections 42221 are in close contact with each other and connected to the first flow channel 4221 and the second flow channel 4223, respectively, such that the two curved sections 42221 are combined to form a comb-shaped curved flow channel structure. When the cooling liquid is conveyed inside the intermediate flow channel 4222, the cooling liquid can sequentially pass through the two curved sections 42221 to increase the length of the cooling liquid's flow path. This arrangement can improve the heat dissipation and heat conduction effects of the heat dissipation structure 420 and allows the heat dissipation structure 420 to have a compact overall structure, which facilitates the miniaturization of the heat dissipation structure 420.

Referring to FIG. 14(b), in Embodiment II, the intermediate flow channel 4222 includes at least one curved section 42221 and a connecting section 42222, and the connecting section 42222 is connected between a second flow channel 4223 (a first flow channel 4221) and the curved section 42221. With such an arrangement, when the first flow channel 4221 in the embodiment serves as a liquid inlet flow channel, the cooling liquid can be quickly discharged from the second flow channel 4223 through the connecting section 42222 after passing through the curved section 42221, thereby reducing heat accumulation inside the heat dissipation structure 420 to improve the heat dissipation effect of the heat dissipation structure 420.

Referring to FIG. 14(c), in Embodiment III, the first flow channel 4221 and the second flow channel 4223 are symmetrically arranged, and the first flow channel 4221 and the second flow channel 4223 are arranged around the liquid inlet hole 4211 and the liquid outlet hole 4212, respectively. Moreover, the intermediate flow channel 4222 includes at least two curved sections 42221 arranged in close contact with each other. With such an arrangement, the heat can be evenly distributed on the surface of the heat dissipation structure 420, thereby improving the heat dissipation effect of the heat dissipation structure 420.

It should be noted that the length size of the heat dissipation structure 420 in Embodiments I and II may be half of the length size of the heat dissipation structure 420 in Embodiment III. With such an arrangement, when the heat dissipation structure 420 in Embodiment III needs to be replaced with the heat dissipation structure 420 in Embodiment I and/or Embodiment II, the two heat dissipation structures 420 in Embodiment I and Embodiment II may be arranged side by side to cover the surface of the external heat source as much as possible. In other embodiments, a corresponding number of heat dissipation structures 420 may be selected according to actual usage requirements to ensure that the heat dissipation structures 420 fully cover the surface of the external heat source. Specifically, in the embodiment, the thermoelectric cooler 410 is a semiconductor thermoelectric cooler 410, and the external heat source may be a hot end of the thermoelectric cooler 410.

Referring to FIG. 14(d), in Embodiment IV, the first flow channel 4221 and the second flow channel 4223 are centrosymmetric about a midpoint of a connecting line of the liquid inlet hole 4211 and the liquid outlet hole 4212, and the first flow channel 4221 and the second flow channel 4223 respectively communicate with the intermediate flow channel 4222. A partition structure includes a first partition 42241, a second partition 42242, and flow channel partitions 42243. The first partition 42241 and the second partition 42242 are configured to separate the liquid inlet hole 4211 and the intermediate flow channel 4222, allowing the first flow channel 4221 to be arranged around the liquid inlet hole 4211 to increase the length of the cooling liquid's path within the heat dissipation structure 420. Meanwhile, by arranging a plurality of flow channel partitions 42243 in a staggered manner, an intermediate flow channel 4222 with a plurality of curved sections 42221 can be formed, thereby improving the heat dissipation effect of the heat dissipation structure 420.

Further, the heat dissipation structure 420 further includes a sealing ring 423. The sealing ring 423 is disposed between the heat dissipation cover plate 421 and the heat dissipation water tank 422, and the sealing ring 423 is arranged around the heat dissipation flow channel and configured to seal a gap between the heat dissipation cover plate 421 and the heat dissipation water tank 422.

With such an arrangement, when assembling the heat dissipation cover plate 421 and the heat dissipation water tank 422, the sealing ring 423 is used to seal the gap therebetween, such that the sealing effect of the heat dissipation structure 420 can be further improved. In an embodiment, a groove for accommodating the sealing ring 423 may be formed on one surface of the inner side of the heat dissipation cover plate 421 and/or the heat dissipation water tank 422, and the groove is arranged around the heat dissipation flow channel. During assembly, the groove may cooperate with the sealing ring 423 to position the installation of the sealing ring 423. Meanwhile, after the heat dissipation cover plate 421 and the heat dissipation water tank 422 are combined, the sealing ring 423 may be compressed to deform and fill the groove. Specifically, the sealing ring 423 includes, but is not limited to, a rubber sealing ring, a silica gel sealing ring, or a sealant.

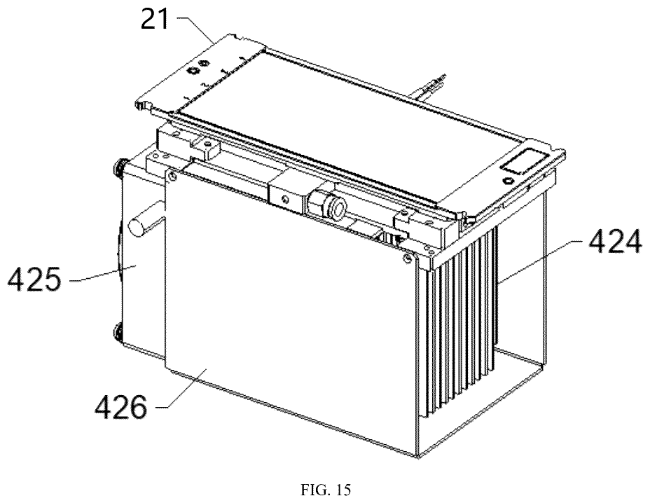

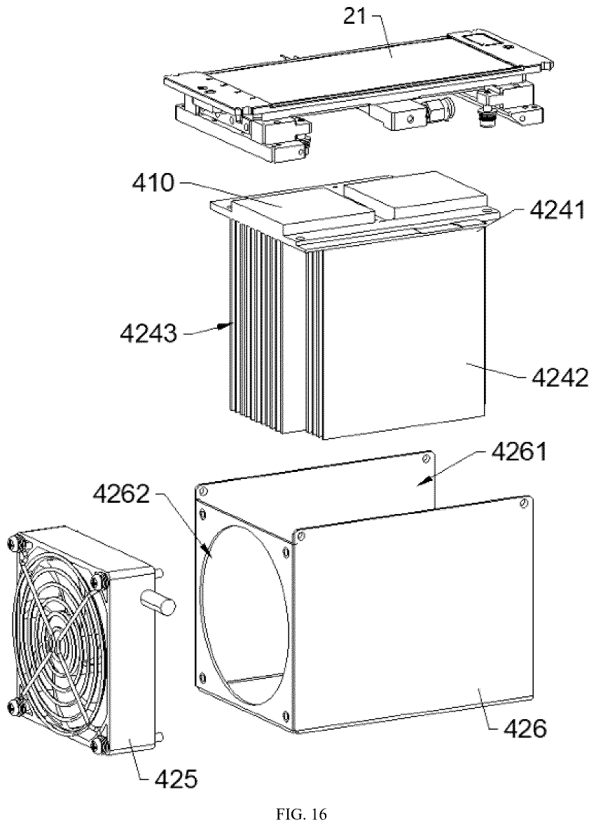

Referring to FIGS. 15 and 16, in another embodiment, the heat dissipation structure 420 includes a heat dissipation frame 424 and a fan 425. The heat dissipation frame 424 is in contact with the thermoelectric cooler 410, an air guiding groove 4243 is formed on one side of the heat dissipation frame 424 away from the thermoelectric cooler 410; the fan 425 is disposed on one side of the air guiding groove 4243 and configured to drive external airflow through the air guiding groove 4243.

In the embodiment, the flow cell 21 is connected to the heat dissipation frame 424 through the thermoelectric cooler 410 and conducts heat. When the thermoelectric cooler 410 is configured to cool the flow cell 21, the heat of the thermoelectric cooler 410 can be conducted to the heat dissipation frame 424, and the fan 425 can be started to drive external air through the heat dissipation frame 424 and discharge the heat. When the flow cell 21 needs to be cooled, similarly, by arranging the heat dissipation frame 424 to cooperate with the fan 425, a heat conduction function for the thermoelectric cooler 410 can also be achieved, thereby enabling the thermostat assembly 400 to perform a temperature control function on the flow cell 21.

Specifically, the heat dissipation frame 424 includes a thermally conductive part 4241 and a plurality of heat dissipation fins 4242 that are connected. The plurality of heat dissipation fins 4242 are spaced apart from each other to form the air guiding groove 4243; one side of the thermally conductive part 4241 is in contact with the thermoelectric cooler 410, and the heat dissipation fins 4242 are disposed on one side of the thermally conductive part 4241 away from the thermoelectric cooler 410.

It can be understood that the heat dissipation fins 4242 are spaced apart from each other to form the air guiding groove 4243 for airflow. In this case, the arrangement of a plurality of heat dissipation fins 4242 can increase the overall heat dissipation area of the heat dissipation frame 424, thereby improving the heat dissipation effect of the heat dissipation frame 424.

In an embodiment, the heat dissipation structure 420 further includes a wind shield 426. An air guiding cavity 4261 is formed inside wind shield 426, and an air inlet hole 4262 that communicates with the air guiding cavity 4261 is formed on the side wall of the wind shield 426; the heat dissipation frame 424 is accommodated within the air guiding cavity 4261, and the fan 425 is disposed on the outer side of the air inlet hole 4262.

In the embodiment, the wind shield 426 serves as a mounting carrier for accommodating the heat dissipation frame 424 and fixing the fan 425. In this case, by disposing the heat dissipation frame 424 in the air guiding cavity 4261 of the wind shield 426, the direction of the external airflow can be guided, such that the external airflow can flow in the direction of the air guiding groove 4243, thereby improving the heat transfer efficiency of the airflow.

The sequencing system according to the embodiments of the present disclosure includes the carrier apparatus 100.

In this way, the sequencing system facilitates the detection of the flow cell 21 on the carrier apparatus 100, offering convenient operation, high sequencing efficiency, and high detection precision. The sequencing system includes, but is not limited to, a nucleic acid sequence determination system.

In the description of the specification, references to the terms such as “an embodiment”, “some embodiments”, “schematic embodiments”, “examples”, “specific examples”, or “some examples” mean that the specific feature, structure, material, or characteristic described in connection with the embodiment or example is included in at least one embodiment or example of the present disclosure. In the specification, the schematic description of the aforementioned terms does not necessarily refer to the same embodiment or example. Moreover, the specific feature, structure, material, or characteristic described may be combined in any appropriate manner in any one or more embodiments or examples.

Although the embodiments of the present disclosure have been illustrated and described, it can be understood by those of ordinary skill in the art that various changes, modifications, replacements, and variations can be made to these embodiments without departing from the principle and purpose of the present disclosure, and the scope of the present disclosure is defined by the claims and equivalents therefore.

1-45. (canceled)

46. A carrier apparatus, comprising:
a carrier platform, wherein the carrier platform comprises a table surface, the table surface being detachably connected to a flow cell assembly; the flow cell assembly comprises a flow cell, with a fluid inlet and a fluid outlet being respectively formed at both ends of the flow cell; and
a fluid connecting assembly and a movement mechanism, wherein the fluid connecting assembly comprises a manifold arranged in correspondence with the fluid inlet and the fluid outlet; and
the movement mechanism drives the fluid connecting assembly to move, comprising: when the fluid connecting assembly is located at a first position, the fluid connecting assembly and the flow cell assembly form a fluid communication through the manifold with the fluid inlet and the fluid outlet; and when the fluid connecting assembly is located at a second position, communication between the fluid connecting assembly and the flow cell assembly is cut off.

47. The carrier apparatus according to claim 46, wherein the fluid connecting assembly comprises a support member, the manifold being arranged on the support member.

48. The carrier apparatus according to claim 47, wherein the fluid connecting assembly comprises an elastic member, wherein the elastic member is connected to the manifold, and the elastic member is configured to maintain the manifold in a tendency to move toward the flow cell.

49. The carrier apparatus according to claim 47, wherein the movement mechanism comprises a cam and a rotation shaft, wherein the cam is connected to the rotation shaft, and the rotation shaft is capable of driving the cam to rotate; and
the cam is further connected to the support member, and the cam, when rotating, drives the manifold on the support member to move to the first position or the second position.

50. The carrier apparatus according to claim 49, wherein a limiting hole is formed on the support member, the cam is arranged in the limiting hole, and the limiting hole cooperates with the cam, such that the cam, when rotating, is capable of driving the manifold on the support member to move to the first position or the second position.

51. The carrier apparatus according to claim 50, wherein the limiting hole is square and comprises a first inner wall and a second inner wall, wherein when the cam abuts against the first inner wall, the cam drives the manifold to move away from the flow cell; and
when the cam abuts against the second inner wall, the cam drives the manifold to move close to the flow cell.

52. The carrier apparatus according to claim 51, wherein the limiting hole comprises a third inner wall, wherein the third inner wall is arranged opposite the first inner wall and arranged closer to the manifold than the first inner wall; and
when the cam abuts against the third inner wall, the cam drives the manifold to move close to the flow cell.

53. The carrier apparatus according to claim 46, wherein adsorption groove channels are formed on the table surface of the carrier platform, the adsorption groove channels being evenly distributed on the table surface; and the carrier apparatus further comprises a negative-pressure system, the negative-pressure system communicating with the adsorption groove channels.

54. The carrier apparatus according to claim 53, wherein the negative-pressure system comprises:
a negative-pressure assembly, configured to generate negative pressure within the adsorption groove channels, wherein the negative-pressure assembly comprises a first pump and a first valve, the first valve being configured to switch between a first operating state and a second operating state, wherein when the first valve is in the first operating state, the first valve communicates with the first pump and the adsorption groove channels; and
when the first valve is in the second operating state, communication between the first pump and the adsorption groove channels is cut off, and the first valve communicates with the adsorption groove channels and an external atmosphere.

55. The carrier apparatus according to claim 54, wherein the negative-pressure system further comprises a gas-water separation assembly, wherein the gas-water separation assembly communicates with the negative-pressure assembly and the adsorption groove channels, and the gas-water separation assembly is configured to separate gas and liquid in the negative-pressure system.

56. The carrier apparatus according to claim 55, wherein the gas-water separation assembly comprises a gas-water separator and a waste liquid tank, the gas-water separator comprising a first port, a second port, and a third port, wherein the first port of the gas-water separator communicates with the adsorption groove channels, the second port of the gas-water separator communicates with the waste liquid tank, and the third port of the gas-water separator communicates with the negative-pressure assembly.

57. The carrier apparatus according to claim 56, wherein the gas-water separation assembly further comprises a second pump, wherein the second pump communicates with the gas-water separator and the waste liquid tank, respectively, and the second pump is configured to drive liquid within the gas-water separator toward the waste liquid tank for conveyance.

58. The carrier apparatus according to claim 46, further comprising a thermostat assembly, the thermostat assembly being at least partially in contact with the carrier platform.

59. The carrier apparatus according to claim 58, further comprising a heat insulation plate, wherein the heat insulation plate encloses the thermostat assembly, and the heat insulation plate is connected to the carrier platform.

60. The carrier apparatus according to claim 58, wherein the thermostat assembly comprises a thermoelectric cooler and a heat dissipation structure, wherein the thermoelectric cooler is connected between the heat dissipation structure and the carrier platform, and the heat dissipation structure is configured to exchange heat with the thermoelectric cooler.

61. The carrier apparatus according to claim 60, wherein the heat dissipation structure comprises a heat dissipation cover plate and a heat dissipation water tank, wherein a heat dissipation flow channel is formed inside the heat dissipation water tank, and the heat dissipation cover plate is detachably connected to the heat dissipation water tank and covers the heat dissipation flow channel, the heat dissipation flow channel being configured to convey cooling liquid and conduct heat, and a liquid inlet hole and a liquid outlet hole that respectively communicate with the heat dissipation flow channel being formed on the heat dissipation cover plate.

62. The carrier apparatus according to claim 61, wherein the heat dissipation flow channel comprises a first flow channel, an intermediate flow channel, and a second flow channel, wherein the first flow channel communicates with the liquid inlet hole; the intermediate flow channel communicates with the first flow channel and is located on one side of the first flow channel; the second flow channel communicates with the intermediate flow channel and the liquid outlet hole, respectively, and the second flow channel is located on one side of the intermediate flow channel facing the first flow channel,
wherein the liquid inlet hole and the liquid outlet hole are respectively formed on a same side of the heat dissipation structure, and the first flow channel and the second flow channel are symmetrically arranged.

63. The carrier apparatus according to claim 62, wherein the first flow channel and the second flow channel are centrosymmetric about a midpoint of a connecting line of the liquid inlet hole and the liquid outlet hole, and the first flow channel and the second flow channel respectively communicate with the intermediate flow channel.

64. The carrier apparatus according to claim 62, wherein the first flow channel is at least partially arranged in a curved manner, and an orthographic projection of the liquid inlet hole on the heat dissipation structure is at least partially located within the first flow channel;
and/or the second flow channel is at least partially arranged in a curved manner, and an orthographic projection of the liquid outlet hole on the heat dissipation structure is at least partially located within the second flow channel.

65. A sequencing system, comprising the carrier apparatus according to claim 46.
